(19) United States
(12) Patent Application Publication
(10) Pub. No.: US 2006/0096383 A1
(43) Pub. Date: May 11, 2006

(54) Lead wire routing structure for pressure-sensitive sensor of vehicle door

(75) Inventors: Tokihiko Yamamoto, Nisshin-shi (JP); Kazuo Nimura, Okazaki-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/268,481

(22) Filed: Nov. 8, 2005

(30) Foreign Application Priority Data
Nov. 8, 2004 (JP) 2004-323674

(51) Int. Cl. G01B 7/16

(52) U.S. Cl. 73/773

(57) ABSTRACT

A lead wire routing structure for a pressure-sensitive sensor of a vehicle door includes a lead wire connected to a pressure-sensitive sensor that is attached along an edge of a door and positioned within the door by penetrating through a through-hole formed on the door, wherein the lead wire arranged from the pressure-sensitive sensor to the through-hole, and the through-hole are covered by a cover portion integrally formed on the pressure-sensitive sensor.

### CROSS REFERENCE TO RELATED APPLICATIONS

This application is based on and claims priority under 35 U.S.C. § 119 to Japanese Patent Application No. 2004-323674, filed on Nov. 8, 2004, the entire content of which is incorporated herein by reference.

### FIELD OF THE INVENTION

This invention generally relates to a lead wire routing structure for a pressure-sensitive sensor of a vehicle door.

### BACKGROUND

A known sliding door opening and closing device for opening and closing a sliding door by means of an actuator is equipped with a pressure-sensitive sensor for detecting that an object bumps into a front edge of the sliding door for the purpose of stopping or reversing an operation of the sliding door while closing. Such the pressure-sensitive sensor includes a sensor main body portion incorporating therein multiple conductors having gaps therebetween, a holding portion having elasticity so as to hold the sensor main body portion, and an attaching portion for attaching the holding portion to the sliding door. The pressure-sensitive sensor is assembled on the sliding door by engaging the attaching portion with a flange portion formed on a front edge of the sliding door over an entire height thereof, or a bracket formed along the flange portion.

That is, the pressure-sensitive sensor is attached to the door as the attaching portion engages with the bracket arranged on an inner side of the flange portion formed on the front edge of the sliding door, or as the attaching portion directly engages with the flange portion. A lead wire of the pressure-sensitive sensor is positioned within the door by passing through a through-hole formed on a side edge of the door.

A pressure-sensitive sensor disclosed in JP2000-199375A engages with a bracket arranged on an inner side of a flange formed on a front edge of a sliding door. Then, a lead wire of the pressure-sensitive sensor and a through-hole are covered by a part of the bracket for the purposes of protecting the lead wire. Further, a pressure-sensitive sensor disclosed in JP09-264094A engages directly with a flange formed on a front edge of a sliding door.

According to the pressure-sensitive sensor disclosed in JP09-264094A, the pressure-sensitive sensor engages directly with the flange portion formed on the front edge of the sliding door. Thus, the lead wire of the sensor is not covered by a bracket used for attaching the pressure-sensitive sensor. The lead wire is exposed, i.e. not protected, and then a passenger may contact with the lead wire, thereby causing breakage thereof.

Thus, a need exists for a lead wire routing structure for a pressure-sensitive sensor of a vehicle in which a lead wire and a through-hole can be covered without using a bracket for attaching a pressure-sensitive sensor or any other parts.

### SUMMARY OF THE INVENTION

According to an aspect of the present invention, a lead wire routing structure for a pressure-sensitive sensor of a vehicle door includes a pressure-sensitive sensor installed along an edge of the vehicular door with a through-hole; an electronic device provided in the vehicular door; a lead wire passing through the through-hole of the vehicular door and connected between the pressure-sensitive sensor and the electronic device; and a cover member formed integrally with the pressure-sensitive sensor and covering the lead wire and the through-hole.

### BRIEF DESCRIPTION OF THE DRAWINGS

The foregoing and additional features and characteristics of the present invention will become more apparent from the following detailed description considered with reference to the accompanying drawings, wherein:

FIG. 1 is an external view of a sliding door of a vehicle to which a lead wire routing structure for a pressure-sensitive sensor of a vehicle is applied according to an embodiment of the present invention;

FIG. 2 is a cross-sectional view taken along the line II-II in FIG. 1;

FIG. 3 is a perspective view of the lead wire routing structure for a pressure-sensitive sensor of a vehicle according to the embodiment of the present invention; and

FIG. 4 is a cross-sectional view taken along the line IV-IV in FIG. 1.

### DETAILED DESCRIPTION

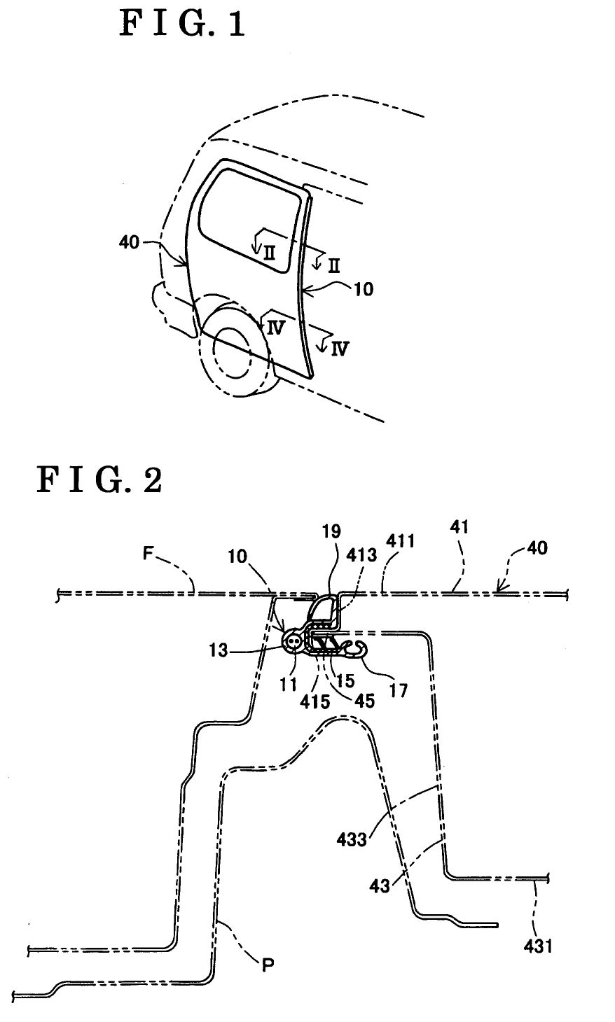

An embodiment of the present invention is explained with reference to the attached drawings. As shown in FIG. 1, an electrically operated sliding door includes a sliding door 40 supported on a vehicle body so as to be slidable in a longitudinal direction of a vehicle along a side wall of the vehicle body, and a driving portion (not shown) for driving the sliding door 40 to slide. In addition, a pressure-sensitive sensor 10 is arranged on a front edge of the sliding door 40 so as to extend along an overall height thereof. An opening operation of the sliding door 40 is defined as a movement in a rearward direction of the vehicle (left side in FIG. 1) while a closing operation of the sliding door 40 is defined as a movement in a forward direction of the vehicle (right side in FIG. 1). Further, as shown in FIG. 2, a front door F is arranged on a front side of the sliding door 40 in the vehicle longitudinal direction. The front edge of the sliding door 40 is positioned adjacent to a rear edge of the front door F. A pillar P is arranged on a vehicle interior side in the vicinity of the front edge of the sliding door 40 and the rear edge of the front door F for the purposes of defining respective areas to be opened or closed by the sliding door 40 and the front door F.

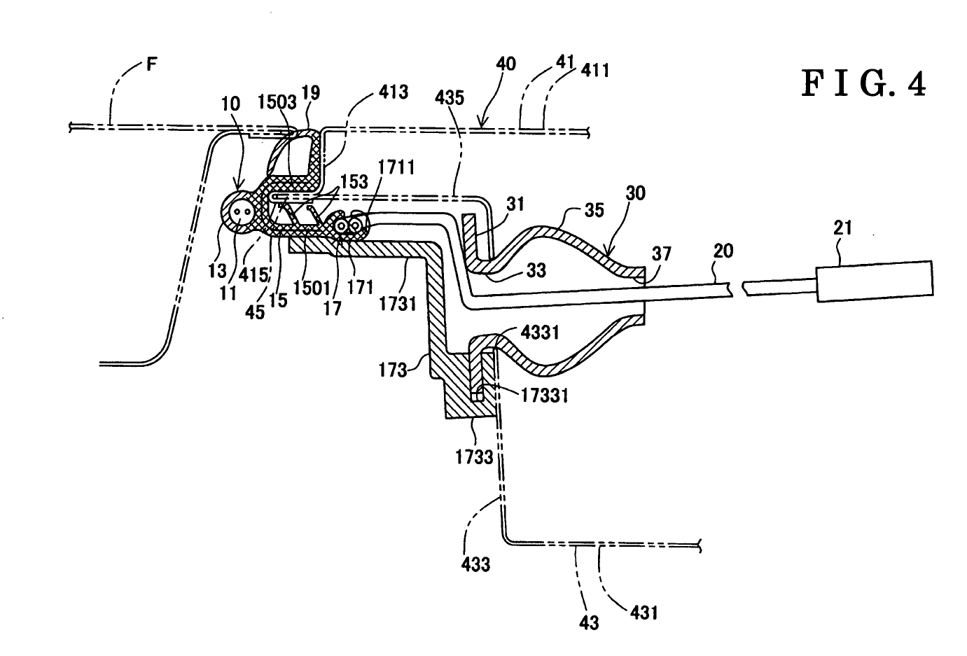

As shown in FIGS. 2 and 4, the sliding door 40 is of a hollow shape constituted by a door panel that includes an outer panel 41 and an inner panel 43 connected to each other at each periphery. The outer panel 41 includes a decorative portion 411 formed to fit a designed shape of the vehicle body, a stepped portion 413 bent into an L-shape towards the inner panel 43 at a front end portion of the decorative portion 411, and a hemming portion 415 extending continuously from the stepped portion 413 in the forward direction of the vehicle and then bent so as to pinch a flange portion 45 (to be explained later) while overlapping a tip end portion of the flange portion 45 of the inner panel 43.

The inner panel 43 includes an inner side portion 431 constituting an inner wall of the vehicle interior, a front wall portion 433 bent towards the outer panel 41 from an outer periphery of the inner side portion 431, and an outer peripheral portion 435 extending in the forward direction of the vehicle from the front wall portion 433. A through-hole 4331 through which a lead wire 20 penetrates is formed at a specified position on the front wall portion 433 whose height is substantially equal to that of a second cover portion 173 provided on the pressure-sensitive sensor 10. A vertically peripheral edge of the outer peripheral portion 435 is pinched by the hemming portion 415 of the outer panel 41. That is, the outer panel 41 and the inner panel 43 are connected to each other. The hemming portion 415 and a specified portion of the outer peripheral portion 435 pinched by the hemming portion 415 are hereinafter called a flange portion 45.

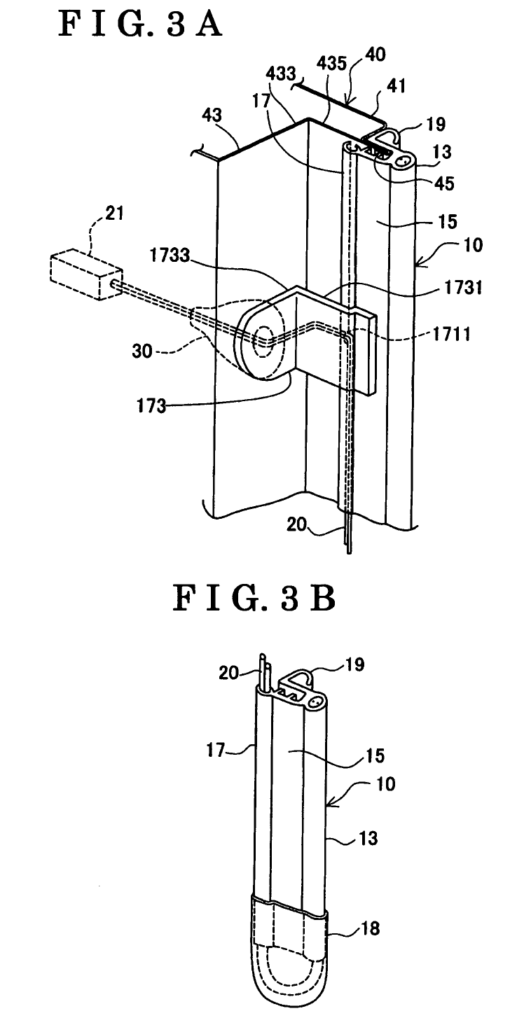

As shown in FIGS. 3A and 4, the pressure-sensitive sensor 10 includes a sensor main body 11, a holding portion 13 of a hollow cylinder shape for accommodating therein and holding the sensor main body 11, an attaching portion 15 extending into a substantially U-shape from the holding portion 13 so as to be assembled on the flange portion 45, a cover portion 17 extending from an inner arm portion 1501 of the attaching portion 15 so as to cover the lead wire 20, and a seal portion 19 continuously and outwardly extending from an outer arm portion 1503 of the attaching portion 15 and bending forwardly and then inwardly in the vehicle for sealing a gap formed between the front edge of the sliding door 40 and the rear edge of the front door F.

The sensor main body 11 is formed of a conductive rubber in which multiple conductors are sealingly filled. The sensor main body 11 has a height substantially equal to that of the sliding door 40. The lead wire 20 is connected to the conductors of the sensor main body 11 on a lower side thereof. Various types of the sensor main body 11 are available and thus detailed explanation is omitted. Basically, the sensor main body 11 detects that an external pressure is applied on the basis of change in voltage at a time that the internal conductors are made contact each other due to pressure from the outside.

The holding portion 13 is formed of a sponge rubber that is soft and easily deformable. The holding portion 13 is of an elongated hollow cylinder shape and has a height substantially equal to that of the sliding door 40. The attaching portion 15 extends continuously in a vehicle rearward direction from the holding portion 13, and within which core metal is pinched. The attaching portion 15 has a substantially U-shape made up of the inner arm portion 1501 that is inwardly formed in the vehicle relative to the outer arm portion 1503, and the outer arm portion 1503 that is outwardly formed in the vehicle relative to the inner arm portion 1501, i.e. a double-hatching portion shown in FIG. 4 molded with rigid resin material.

As shown in FIG. 4, multiple leg portions 153 are formed on a surface of the inner arm portion 1501 facing the outer arm portion 1503. The multiple leg portions extend towards the outer arm portion 1503 and pinch the flange portion 45 together with the outer arm portion 1503 when the attaching portion 15 is fitted with the flange portion 45. Metal spring material as the core metal is inserted into each middle portion of the inner arm portion 1501 and the outer arm portion 1503 in each thickness direction thereof for the purposes of increasing force to pinch the flange portion 45.

The cover portion 17 extends in a vehicle rearward direction further from the inner arm portion 1501 of the attaching portion 15 having a height substantially equal to that of the sliding door 40. Specifically, the cover portion 17 includes a first cover portion 171 having a C-shape in cross section for covering and holding the lead wire 20, and a second cover portion 173 having an L-shape in cross section and integrally formed on each outer surface of the inner arm portion 1501 and the first cover portion 171 at a height at which the second cover portion 173 can cover the through-hole 4331 into which the lead wire 20 penetrates. As shown in FIGS. 3A and 4, a notch portion 1711 is formed on the first cover portion 171 such that the lead wire 20 located inside of the first cover portion 171 projects therefrom by bending horizontally at a position whose height is substantially equal to that of the through-hole 4331. Since the holding portion 13 and the first cover portion 171 are arranged away from each other, a detection ability of the sensor main body 11 is not affected by the first cover portion 171.

The second cover portion 173 includes a connection portion 1731 integrally formed on respective outer surfaces of the inner arm portion 1501 and the first cover portion 171 so as to extend in a vehicle rearward direction, and a grommet joint portion 1733 extending from a rear end of the connection portion 1731 towards a vehicle interior side. A vertical length of the second cover portion 173 is greater than that of a flange portion 31 of a grommet 30 (to be explained later). Further, an engaging groove 17331 is formed on a rear end face of the grommet joint portion 1733 as shown in FIG. 4 so that the flange portion 31 of the grommet 30 engages with the engaging groove 17331.

As shown in FIG. 4, the grommet 30 includes the flange portion 31 of a doughnut-like disc shape, an entrance portion 33 extending from an inner hole of the flange portion 31 in a cylindrical manner, a bulged portion 35 outwardly bulging from the entrance portion 33 and whose diameter is then gradually reduced towards an end portion of the grommet 30 provided on an opposite side to the entrance portion 33, and an exit portion 37 including an opening portion through which a connector 21 attached to the lead wire 20 can pass. The grommet 30, within which the lead wire 20 is positioned, is assembled on the second cover portion 173 such that the flange portion 31 of the grommet 30 engages with the engaging groove 17331 formed on the second cover portion 173. Further, after the bulged portion 35 of the grommet 30 is inserted into the through-hole 4331, the entrance portion 33 engages with the through-hole 4331, thereby assembling the grommet 30 on the through-hole 4331.

As shown in FIG. 3B, a molding portion 18 is formed on a lower end portion of the pressure-sensitive sensor 10 so as to cover a range from the holding portion 13 through the inner arm portion 1501 and the first cover portion 171 for the purposes of protecting the lead wire 20. The molding portion 18 is injection molded in a state in which the lead wire 20 connected to the conductors of the pressure-sensitive sensor 10 is upwardly bent so as to be located within the first cover portion 171. The lead wire 20 then horizontally projects from the first cover portion 171 through the notch portion 1711 formed on a substantially middle portion in a height direction of the second cover portion 173. Finally the lead wire 20 is brought to penetrate through inside of the grommet 30.

Next, a manufacturing method and an assembly method of the pressure-sensitive sensor 10 are explained below. First, the pressure-sensitive sensor 10 is assembled. That is, the sensor main body 11 is inserted into the hollow cylinder portion, which has been bulged, of the holding portion 13 over an entire length thereof. The lead wire 20 is connected to the conductors of the sensor main body 11 at a lower portion thereof and then bent into a U-shape so as to be fitted into the first cover portion 171 from a lower side of the holding portion 13. The lead wire 20 then projects from the first cover portion 171 through the notch portion 1711.

In such circumstances, a lower end portion of the pressure-sensitive sensor 10 is inserted into a die of an injection-molding machine, which is then filled with synthetic resin so as to form the molding portion 18. The conductors of the sensor main body 11 and the lead wire 20 are covered by the molding portion 18 accordingly. Then, after demolding, the connector 21 attached to the tip end of the lead wire 20 projecting from the notch portion 1711 is inserted into the entrance portion 33 towards the exit portion 37 of the grommet 30, and pulled out therefrom. After also pulling out the lead wire 20, the flange portion 31 of the grommet 30 is brought into engagement with the engaging groove 17331 formed on the grommet joint portion 1733 of the second cover portion 173 so that the grommet 30 is assembled on the cover portion 17.

In order to assemble on the sliding door 40 the pressure-sensitive sensor 10 with the grommet 30 within which the lead wire 20 is positioned, the connector 21, and then the bulged portion 35 of the grommet 30 attached to the pressure-sensitive sensor 10 are inserted into the through-hole 4331 of the inner panel 43. Then, due to attachment of the grommet 30, a position in a height direction of the pressure-sensitive sensor 10 relative to the flange portion 45 is determined. The attaching portion 15 is pressed towards the flange portion 45 from a vehicle forward direction so that the flange portion 45 is sandwiched between the arm portions 1501 and 1503. Accordingly, the pressure-sensitive sensor 10 is assembled on the flange portion 45 formed on the vertical edge of the sliding door 40. After completion of assembly of the pressure-sensitive sensor 10 on the sliding door 40, the connector 21 is connected to a wire harness in the sliding door 40.

The aforementioned embodiment can be modified as follows. For example, the pressure-sensitive sensor 10 is directly assembled on the flange portion 45 that is constituted by the door panel according to the present embodiment. However, instead, the pressure-sensitive sensor 10 may be assembled on a bracket arranged in parallel to the flange portion 45. Further, the first cover portion 171 is formed on the tip end of the inner arm portion 1501 according to the present embodiment. However, instead, the first cover portion 171 may be formed on a side portion of the inner arm portion 1501. Furthermore, the grommet 30 may be integrally formed on the first cover portion 171.

According to the aforementioned embodiment, the lead wire 20 arranged from the pressure-sensitive sensor 10 to the through-hole 4331 formed on the inner panel 43 of the sliding door 40 is entirely covered by the cover portion 17 integrally formed on the attaching portion 15, without providing another part, thereby achieving a safe structure of the lead wire routing.

Further, according to the aforementioned embodiment, the lead wire 20 arranged from the pressure-sensitive sensor 10 to the through-hole 4331 is covered by the cover portion 17 integrally formed on the pressure-sensitive sensor 10. Thus, the lead wire 20 may be covered without using a bracket or another part, thereby avoiding the lead wire 20 from being touched by a passenger, and achieving a function of the pressure-sensitive sensor 10.

Furthermore, according to the aforementioned embodiment, the cover portion 17 for covering the lead wire 20 and the through-hole 4331 is integrally formed on the attaching portion 15. Thus, the detecting ability of the pressure-sensitive sensor 10 may not be affected by the holding portion 13, on the other hand the detection ability may be affected in cases where a cover portion is formed on a holding portion.

Furthermore, according to the aforementioned embodiment, the through-hole 4331 is equipped with the grommet 30 that holds the lead wire 20 and that engages with the cover portion 17. Thus, a positional relationship between the pressure-sensitive sensor 10 and the grommet 30 is surely determined, thereby reducing time for assembling the pressure-sensitive sensor 10 on the sliding door 40.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A lead wire routing structure for a pressure-sensitive sensor of a vehicle door comprising:
a pressure-sensitive sensor installed along an edge of the vehicular door with a through-hole;
an electronic device provided in the vehicular door;
a lead wire passing through the through-hole of the vehicular door and connected between the pressure-sensitive sensor and the electronic device; and
a cover member formed integrally with the pressure-sensitive sensor and covering the lead wire and the through-hole.

2. A lead wire routing structure according to claim 1, wherein the pressure-sensitive sensor includes a sensor main body portion, a holding portion for holding the sensor main body portion, and an attaching portion for attaching the holding portion to the vehicular door, the attaching portion being formed integrally with the cover member.

3. A lead wire routing structure according to claim 1, wherein the through-hole is equipped with a grommet for holding the lead wire, and the grommet engages with the cover portion.

4. A lead wire routing structure according to claim 2, wherein the through-hole is equipped with a grommet for holding the lead wire, and the grommet engages with the cover portion.

5. A lead wire routing structure according to claim 1, wherein the pressure-sensitive sensor is directly assembled on a flange portion of the vehicular door.

6. A lead wire routing structure according to claim 2, wherein the pressure-sensitive sensor is directly assembled on a flange portion of the vehicular door.

7. A lead wire routing structure according to claim 1, wherein the pressure-sensitive sensor is resin-molded.

8. A lead wire routing structure according to claim 2, wherein the pressure-sensitive sensor is resin-molded.

9. A lead wire routing structure according to claim 1, wherein the electronic device in the vehicular door is a connector.

10. A lead wire routing structure according to claim 2, wherein the electronic device in the vehicular door is a connector.

11. A lead wire routing structure according to claim 1, wherein the cover member includes a first cover portion extending in a vehicle vertical direction and a second cover portion extending from the first cover portion towards the through-hole.

12. A lead wire routing structure according to claim 2, wherein the cover member includes a first cover portion extending in a vehicle vertical direction and a second cover portion extending from the first cover portion towards the through-hole.

13. A lead wire routing structure according to claim 11, wherein a height of the second cover portion in a vehicle vertical direction is substantially equal to that of the through-hole.

14. A lead wire routing structure according to claim 12, wherein a height of the second cover portion in a vehicle vertical direction is substantially equal to that of the through-hole.

15. A lead wire routing structure according to claim 1, wherein the door is in the form of a sliding door.

16. A lead wire routing structure for a pressure-sensitive sensor of a vehicle door according to claim 2, wherein the door in the form of a sliding door.
